(19) United States
(12) Patent Application Publication
(10) Pub. No.: US 2021/0339688 A1
(43) Pub. Date: Nov. 4, 2021

(54) MOTOR VEHICLE HANDLE

(71) Applicant: Huf Huelsbeck & Fuerst GmbH & Co. KG, Velbert (DE)

(72) Inventors: Andreas Beck, Bochum (DE); Peter Bajer, Heiligenhaus (DE)

(73) Assignee: Huf Huelsbeck & Fuerst GmbH & Co. KG, Velbert (DE)

(21) Appl. No.: 17/260,496

(22) PCT Filed: Apr. 30, 2019
(86) PCT No.: PCT/EP2019/061002

§ 371 Date: Jan. 14, 2021

(30) Foreign Application Priority Data
Jul. 25, 2018 (DE) 10 2018 117 954.5

(51) Int. Cl. B60R 16/027; E05B 79/06; E05B 85/16; H01R 13/58

(52) U.S. Cl. CPC B60R 16/027; E05B 79/06; H01R 2201/26; H01R 13/582; E05B 85/16

(57) ABSTRACT

A motor vehicle handle includes a handle body with a first longitudinal end, a second longitudinal end, and a receiving space is formed on the handle body between the first longitudinal end and the second longitudinal end. An electronic module is arranged within the receiving space. At least one cable, which is used to transmit information and/or energy, connects a connection plug to the electronic module. A free end of a bearing arm which can be pivotally mounted on a motor vehicle protrudes from the first longitudinal end of the handle body, and the connection plug is arranged on the bearing arm free end. A strain-relief cable guide element, which is designed to guide the at least one cable, is releasably attached to the handle body and extends between the electronic module and the connection plug.

The invention is directed to a motor vehicle handle comprising a handle body having a first longitudinal end, a second longitudinal end and a receiving space which is formed on the handle body between the first longitudinal end and the second longitudinal end, an electronic module which is arranged within the receiving space, and at least one cable which is used to transmit information and/or energy and which connects a connection plug to the electronic module, a free end of a bearing arm which can be pivotally mounted on a motor vehicle protruding from the first longitudinal end, and the connection plug being arranged on the free end.

Such a motor as handle is known from the prior art and is used to open a door of a motor vehicle, for example, such a motor vehicle handle having a handle body to which an electronic module is attached. As is known, the electronic module is used, inter alia, to check authorization for authorized access to the motor vehicle in a data exchange with a remote key and, in the case of an authorized radio key, to generate corresponding signals to unlock the door of the motor vehicle; this is generally known from the prior art, which is why further details will not be given. The electronic module is connected to at least one cable which is routed along the handle body to a connection plug or the like and is used to transmit energy from a vehicle-side energy source to the electronic module and/or to transmit information from the electronic module to a vehicle-side control device. The laying and arrangement of the at least one cable is problematic, since said cable must be held securely in position during a movement of the handle body when operated by a user or during normal driving operation of the motor vehicle in order to prevent signs of wear caused by the cable chafing on the handle body or other components, and to prevent a reduction in service life associated therewith.

The object of the present Invention is that of providing a solution which provides an improved motor vehicle handle in a structurally simple manner, in which the cabling of the electronic module is securely fixed to the handle body and in which negative impairment of the service life of the cabling is reduced to a minimum.

This object is achieved according to the invention in that a strain-relief cable guide element designed to guide the at least one cable is releasably attached to the handle body and extends between the electronic module and the connection plug.

Advantageous and expedient embodiments and developments of the invention are disclosed in the dependent claims.

The invention provides a motor vehicle handle which is characterized by a simple and inexpensive design. As a result of the component of the strain-relief cable guide element according to the invention, in contrast to the prior art, it is now possible to guide the at least one cable with low tolerances and simultaneously provide strain relief for the cable by means of a single component. In this way, wear of the at least one cable that usually occurs during operation is prevented because the at least one cable can no longer chafe freely and movably on other vehicle components, and the invention therefore increases the service life of the at least one cable and therefore the handle assembly.

In an embodiment, the invention provides that the at least one cable extends at least in portions along a cable duct, a wall portion of the handle body and a lateral wall of the strain-relief cable guide element forming the cable duct. This is particularly structurally favorable, since the strain-relief cable guide element according to the invention is connected to the handle body during assembly, as a result of which the cable duct is also only produced during assembly, and the at least one cable can therefore be brought into position in a simple manner so that it is arranged within the cable duct after assembly.

A particularly favorable option for producing a strain relief for the at least one cable is given in a further embodiment of the invention in that the lateral wall of the strain-relief cable guide element has a clamping lug which protrudes into the cable duct in such a way that a portion of the at least one cable is held clamped between the clamping lug and the wall portion of the handle body.

In order to guide and securely hold the at least one cable, in a further embodiment it is particularly advantageous if two cable retaining projections are formed on the strain-relief cable guide element, which projections extend opposite one another and on each of which a retaining arm protrudes at the end, which retaining arm extends in the direction of the opposite cable retaining projection. In this case, the retaining arms can be directed inward, so that they form a type of barb, in order to hold the at least one cable securely between said arms.

With regard to guiding the at least one cable, the invention provides in a further embodiment that the strain-relief cable guide element is L-shaped, having a first leg and a second leg, the at least one cable being arranged so as to run along the first leg, which extends in a longitudinal direction of the handle body and in the direction of the connection plug, and the second leg, which extends transversely to the longitudinal direction of the handle body and in the direction of the electronic module, and being arranged on the outside of the L-shape of the strain-relief cable guide element.

With regard to a simple assembly, it is advantageous if, in a further embodiment of the invention, the strain-relief cable guide element is releasably connected to the handle body by means of a clamping connection.

In this context, it is particularly structurally favorable if the clamping connection has at least one clamping recess formed on the second leg of the strain-relief cable guide element and at least one clamping strip formed on the handle body, the shape of which clamping strip is adapted to the contour of the clamping recess, the damping strip being arranged in the clamping recess.

In an embodiment of the invention, it is also advantageous for assembly and for the clamping connection if the clamping connection has at least one clamping projection which is formed on the handle body and on which the first leg and the second leg of the strain-relief cable guide element are supported at an angle so as to extend around the clamping projection. As a result, the at least one clamping projection blocks a movement of the strain-relief cable guide element in the direction of the electronic module.

Finally, in an embodiment of the invention, the lateral wall is formed on a lateral face of the second leg that faces away from the first leg, and the clamping connection has a counter-clamping strip, against which a free end of the first leg rests, the at least one cable which extends through the cable duct applying a clamping force which presses the free end of the first leg against the counter-clamping strip. The cable usually has a resilient insulating material, so that the resilience provides the necessary clamping force and simultaneously allows the strain-relief cable guide element to be removed from the handle body. The counter-clamping strip also blocks a movement of the strain-relief cable guide element in the direction of the connection plug.

It goes without saying that the features mentioned above and those to be explained below can be used not only in the specified combination but also in other combinations or alone, without departing from the scope of the present invention. The scope of the invention is defined only by the claims.

Other details, features, and advantages of the subject matter of the invention can be found in the following description in conjunction with the drawings, in which an exemplary and preferred embodiment of the invention is shown.

In the drawings:

FIG. 1 is a perspective side view of a motor vehicle having a plurality of motor vehicle handles according to the invention,

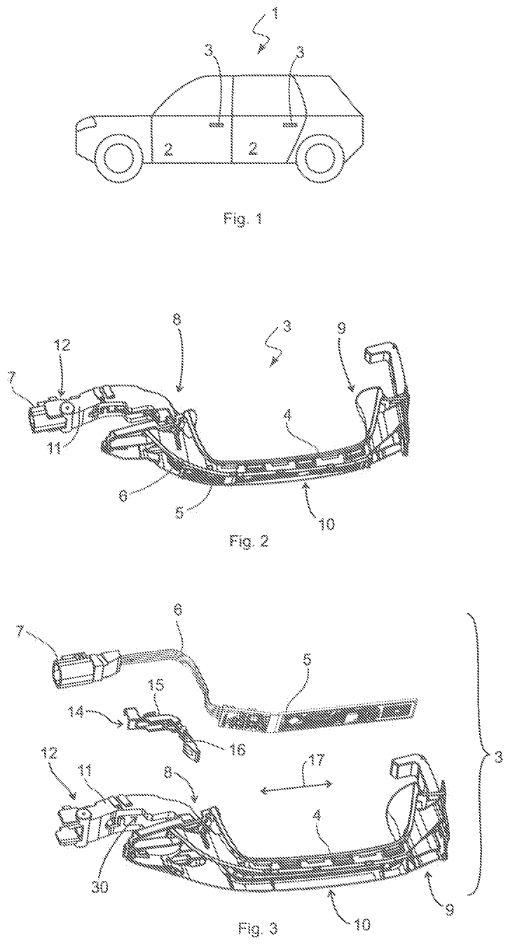

FIG. 2 is a perspective plan view of the motor vehicle handle according to the invention,

FIG. 3 is a perspective view of individual parts of the motor vehicle handle from FIG. 2,

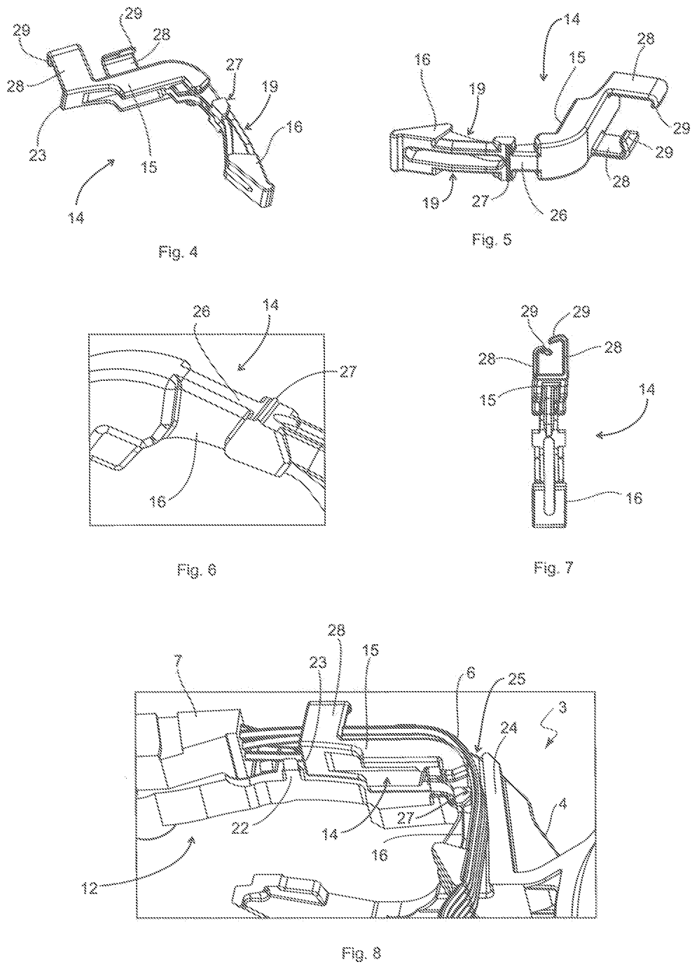

FIG. 4 is a perspective view of a strain-relief cable guide element of the motor vehicle handle,

FIG. 5 is a further perspective view of the strain-relief cable guide element,

FIG. 6 is a further detailed perspective view of the strain-relief cable guide element,

FIG. 7 is a side view of the strain-relief cable guide element,

FIG. 8 is a perspective view of the motor vehicle handle, in which a handle body of the motor vehicle handle is partially shown in cross section,

FIG. 9 shows a detailed view of a cable duct of the motor vehicle handle according to the invention,

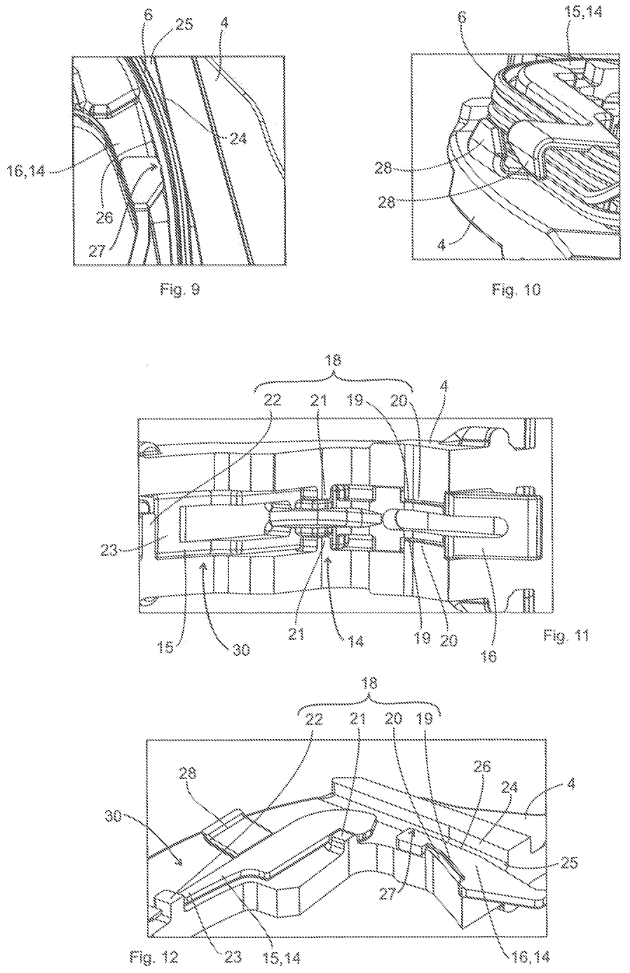

FIG. 10 shows a further detailed perspective view of the strain-relief cable guide element, which holds and guides a large number of cables,

FIG. 11 shows a detailed view of the handle body and the strain-relief cable guide element releasably fastened thereto, and

FIG. 12 shows a perspective sectional view of the handle body and the strain-relief cable guide element releasably fastened thereto.

FIG. 1 shows, by way of example, a motor vehicle 1 in the form of a passenger car, which, in the example, has four vehicle doors 2 (two of which are shown in FIG. 1) which can be opened by means of a relevant motor vehicle handle 3. As an alternative to the embodiment shown in the drawings, the motor vehicle handle 3 according to the invention can also be used on vehicle panels, for example a tailgate or a trunk lid. The motor vehicle handle 3 according to the invention can be seen in greater detail in FIGS. 2 and 3, in which FIG. 2 is a perspective view, whereas FIG. 3 is a perspective view of individual parts of the motor vehicle handle 3. The motor vehicle handle 3 has a handle body 4, an electronic module 5, a plurality of cables 6 and a connection plug 7. In this case, the handle body 4 has a first longitudinal end 8, a second longitudinal end 9 and a receiving space 10. The receiving space 10 is formed on the handle body 4 between the first longitudinal end 8 and the second longitudinal end 9 and is used to receive the electronic module 5 which is arranged and fastened within the receiving space 10. A bearing arm 11 which can be pivotally mounted on the motor vehicle 1 protrudes from the first longitudinal end 8 of the handle body 4, which bearing arm has a free end 12, on which the connection plug 7 is arranged and releasably fastened. The cables 6 are used to transmit information and/or energy and to connect the connection plug 7 to the electronic module 5, such that the electronic module 5 can be supplied with energy via the connection plug 7 and the cables 6 and/or information which the electronic module 5 generates in the course of checking access for an authorized user can be conveyed via the cables 6 and the connection plug 7 to a control unit arranged in the motor vehicle 1. It goes without saying that, in contrast to the specific embodiment, only one single cable 6 can alternatively be provided instead of a plurality of cables 6.

According to the invention, the motor vehicle handle 3 for strain relief and guidance of the cables 6 has a strain-relief cable guide element 14 which is releasably attached to the handle body 4 and which extends between the electronic module 5 and the connection plug 7. The strain-relief cable guide element 14, which is also shown in FIG. 4 to 7 for different views, is L-shaped and has a first leg 15 and a second leg 16, which are connected to one another at the end and therefore each have a free end. The shape of the strain-relief cable guide element 14 is adapted to the shape of the mounting arm 11 since the strain-relief cable guide element 14 extends at least within the bearing arm 11. In this case, the cables 6 are arranged so as to run along the strain-relief cable guide element 14 on the outside with respect to the L-shape, such that the cables 6 run along the first leg 15 and the second leg 16. In a state in which the strain-relief cable guide element 14 is fastened to the handle body 4, the first leg 15 extends in a longitudinal direction 17 of the handle body 4 and in the direction of the connection plug 7 (see, for example, FIG. 3), whereas the second leg 18 extends transversely to the longitudinal direction 17 of the handle body 4 and in the direction of the electronic module 5.

As can also be seen from FIG. 8 to 12, the strain-relief cable guide element 14 is releasably connected to the handle body 4 by means of a clamping connection 18, a recess 30 being formed In the handle body 4 between the connection plug 7 and the electronic module 5, in which recess the strain-relief cable guide element 14 is inserted in a clamping manner in the mounted state on the handle body 4. The clamping connection 18 has a clamping recess 19 formed on the second leg 16 of the strain-relief cable guide element 14 and at least one clamping strip 20 formed on the handle body 4, which is shown, for example, in the sectional view of FIG. 12. In this case, as can be seen from FIG. 5, two clamping recesses 19 are formed on the second leg 16 of the strain-relief cable guide element 14, specifically one clamping recess 19 in each case on the upper face and lower face of the strain-relief cable guide element 14, two clamping strips 20 being formed on the handle body 4, which strips extend in a mutually facing direction and engage in the damning recesses 19 so that the clamping strips 20 engage on both sides in the clamping recesses 19 of the second leg 16 (see for example FIG. 11). The clamping strips 20 are adapted to the contour of the clamping recesses 19, so that the clamping strips 20 are arranged in the clamping recesses 19. It is obvious that, instead of two clamping recesses 19 and two clamping strips 20, only a single clamping recess 19 can be formed on the second leg 16 of the strain-relief cable guide element 14 and only a single clamping strip 20 can be formed on the handle body 4.

As can also be seen from FIGS. 11 and 12, the clamping connection 18 has two clamping projections 21 which protrude into the recess 30 formed in the handle body 4 for the strain-relief cede guide element 14 and are oriented facing one another. In the mounted state on the handle body 4, the first leg 15 and the second leg 16 of the strain-relief cable guide element 14 are supported at an angle so as to extend around the clamping projections 21, so that a movement of the strain-relief cable guide element 14 in the direction of the electronic module 5 is blocked. Here, too, it goes without saying that only a single clamping projection 21 can alternatively be formed on the handle body 4, around which clamping projection the L-shaped strain-relief cable guide element 14 is arranged, and which blocks a movement of the strain-relief cable guide element 14 in the direction of the electronic module 5.

It can also be seen from FIGS. 11 and 12 that the clamping connection 18 also has a counter-clamping strip 22 which is formed on the handle body 4 and which protrudes into the recess 30 formed in the handle body 4 for the strain-relief cable guide element 14. in the mounted state of the strain-relief cable guide element 14, a free end 23 of the first leg 15 rests against the counter-clamping strip 22, so that a movement of the strain-relief cable guide element 14 in the direction of the connection plug 7 is blocked. The counter-clamping strip 22 therefore blocks a movement of the strain-relief cable guide element 14 in the direction of the connection plug 7.

The clamping effect of the damping connection 18 is further provided by the cables 6 being damped between the second leg 16 of the strain-relief cable guide dement 14 and a wall portion 24 of the handle body 4 (see, for example, FIGS. 8 and 9), as a result of which the cables 6 in turn apply a damping force which presses the free end 23 of the first leg 15 against the counter-clamping strip 22. The cables 6 therefore extend at least in portions along a cable duct 25 which is formed by the wall portion 24 of the handle body 4 and a lateral wall 26 of the strain-relief cable guide element 14. In this case, the lateral wall 26 is formed on a lateral face of the second leg 16 that faces away from the first leg 15. The cables 6 arranged inside the cable duct 25 and the wall portion 24 therefore block a movement of the strain-relief cable guide element 14 in a direction pointing away from the connection plug 7. The clamping connection 18 therefore comprises the clamping recesses 19, the clamping strips 20, the clamping projections 21 and the counter-clamping strip 22, the clamping force of the cables 6 clamped in the cable duct 25 pressing the free end 23 of the first leg 15 against the counter-clamping strip 22, and the strain -relief cable guide element 14 being clamped in the recess 30 of the handle body 4, as a result, and simultaneously guiding the cables 6 and relieving strain. The lateral wall 26 of the strain-relief cable guide element 14 has a clamping lug 27 for fixing and strain relief of the cables 6. The clamping lug 27 protrudes into the cable duct 25 in such a way that the cables 6 are clamped between the damping lug 27 and the wall portion 24 of the handle body 4 and held in a tension-relieved manner (see, for example, FIGS. 6, 8 and 9).

In order to guide the cables 6, two cable retaining projections 28 are formed on the strain-relief cable guide element 14, which projections extend opposite one another and on each of which a retaining arm 29 protrudes at the end, which retaining arm extends in the direction of the opposite cable retaining projection 28. The retaining arms 29 are directed inwardly toward one another and form a type of barb for the cables 6, as a result of which the portion of the cables 6 running on the first leg 15 are securely held and guided by the cable holding projections 28 on the strain-relief cable guide element 14.

The described invention is of course not limited to the described and illustrated embodiment. Numerous modifications can be made to the embodiment shown in the drawing, which are obvious to a person skilled in the art according to the intended use, without thereby departing from the scope of the invention. The invention includes everything that is contained in the description and/or shown in the drawing, including anything that, deviating from the specific embodiment, is obvious to a person skilled in the art.

1. Motor vehicle handle comprising a handle body having a first longitudinal end, a second longitudinal end and a receiving space which is formed on the handle body between the first longitudinal end and the second longitudinal end, an electronic module which is arranged within the receiving space, and at least one cable which is used to transmit information and/or energy and which connects a connection plug to the electronic module, a free end of a bearing arm which can be pivotally mounted on a motor vehicle protruding from the first longitudinal end, and the connection plug being arranged on the free end,
wherein
a strain-relief cable guide element which is designed to guide the at least one cable is releasably attached to the handle body and extends between the electronic module and the connection plug.

2. Motor vehicle handle according to claim 1, wherein the at least one cable extends at least in portions along a cable duct, a wall portion of the handle body and a lateral wall of the strain-relief cable guide element forming the cable duct.

3. Motor vehicle handle according to claim 2, wherein the lateral wall of the strain-relief cable guide element has a damping lug which protrudes into the cable duct in such a way that a portion of the at least one cable is held clamped between the damping lug and the wall portion of the handle body.

4. Motor vehicle handle according to claim 1, wherein two cable retaining projections are formed on the strain-relief cable guide element, which projections extend opposite one another and on each of which a retaining arm protrudes at the end, which retaining arm extends in the direction of the opposite cable retaining projection.

5. Motor vehicle handle according to claim 3, wherein the strain-relief cable guide element is L-shaped, having a first leg and a second leg, the at least one cable being arranged so as to run along the first leg, which extends in a longitudinal direction of the handle body and in the direction of the connection plug, and the second leg, which extends transversely to the longitudinal direction of the handle body and in the direction of the electronic module, and being arranged on the outside of the L-shape of the strain-relief cable guide element.

6. Motor vehicle handle according to claim 5, wherein the strain-relief cable guide element is releasably connected to the handle body by means of a clamping connection.

7. Motor vehicle handle according to claim 6, wherein the clamping connection has at least one clamping recess formed on the second leg of the strain-relief cable guide element and at least one clamping strip formed on the handle body, the shape of which at least one clamping strip is adapted to the contour of the at least one clamping recess, the at least one clamping strip being arranged in the at least one clamping recess.

8. Motor vehicle handle according to claim 6, wherein the clamping connection has at least one clamping projection which is formed on the handle body and on which the first leg and the second leg of the strain-relief cable guide element are supported at an angle so as to extend around the at least one clamping projection.

9. Motor vehicle handle according to claim 6, wherein the lateral wall is formed on a lateral surface of the second leg that faces away from the first leg, and the clamping connection has a counter-clamping strip, against which a free end of the first leg rests, the at least one cable which extends through the cable duct applying a clamping force which presses the free end of the first leg against the counter-clamping strip.
